(19) United States
(12) Patent Application Publication
(10) Pub. No.: US 2019/0200583 A1
(43) Pub. Date: Jul. 4, 2019

(54) SUBMERSIBLE FEEDING, CONTROL AND COMMAND PLATFORM

(71) Applicant: António SIMÕES ALVES VIEIRA, Rio De Mouro (PT)

(72) Inventor: António SIMÕES ALVES VIEIRA, Rio De Mouro (PT)

(21) Appl. No.: 16/303,266

(22) PCT Filed: May 26, 2017
(86) PCT No.: PCT/PT2017/000012

§ 371 Date: Nov. 20, 2018

(30) Foreign Application Priority Data
May 31, 2016 (PT) 109416

(51) Int. Cl. A01K 61/80; A01K 61/10; A01K 61/65

(52) U.S. Cl. CPC A01K 61/80; A01K 61/65; A01K 61/10

(57) ABSTRACT

A submersible platform intended to perform the functions of feeding distribution, production control and command of the operations inherent to fish farming in submersible cages, which has the ability to submerge under adverse environmental conditions, returning to the surface, once the environmental conditions so do allow it, enabling thereby the fish farming in offshore spaces. For this purpose it includes a vertical central structure, which constitutes the central core of the platform around which it is arranged the upper structure, which has an outer circulating and mooring space for service vessels, the access to its interior being made through doors, and a lower structure, inside which there are ration storage silos, as well as an insufflation ballasting and deballasting central chamber, which allows the submersion and the emersion of the platform, the balance of the platform being ensured by an additional ballasting and deballasting arrangement within each silo, to compensate for the weight of the consumed ration.

### FIELD OF THE INVENTION

The present invention relates to a submersible platform intended to perform the functions of feeding distribution, production control and command of the operations inherent to the fish farming in submersible cages in open waters, i.e., in locations where adverse ambient conditions can be registered, such as, for example, storms, strong sea agitation, high intensity ocean currents, etc.

### STATE OF THE ART

To improve the control and the productivity of the ration distribution in fish farming in submersible cages there have been developed floating platforms and vessels intended to distribute the feeding to a set of cages. Both floating platforms and vessels have silos for the storage of the rations used and equipments intended to route them to each cage, allowing that the supply be better adjusted to the different needs of each growing population, in terms of feeding period and its distribution rhythm, according to pre-established programs. They also have control devices which are intended to prevent the occurrence of waste, through the possibility of stopping the ration distribution at the first signs of loss of appetite on the part of the fish, which signs are identified by video cameras or by sensors intended to detect the reduction of ration not consumed. These platforms or vessels, in addition to said equipments, also include facilities for the work and rest of the operators.

Although said vessels are able to withstand more severe environmental conditions than the platforms, they have, however, limited ration storage capabilities and they have, in any case, to be taken to the shelter harbour, when the environmental conditions get worse, returning only close to the cages when the environmental conditions so do allow it, that is to say, to be compatible again with the conditions of seaworthiness and with the possibility of surface ration distribution. Often, relatively long periods of time occur wherein the feeding distribution is not realized, which has heavy impacts on the overall productivity of the exploration.

The New Hampshire University (USA) has built a small floating platform capable of withstanding harsher sea agitation conditions than the traditional platforms. Such a platform is not, however, feasible on an industrial scale, since the ratio between its total weight and its ration storage capability is very unfavourable, which is only compatible with small dimension units, storing only a few tonnes of ration, fundamentally intended to be used in experimental programs.

### REFERENCE TO THE RELEVANT BACKGROUND

Reference is made to the following documents:

KR 2012 0034340 A (KIM DONG JOO [KR] 12 Apr. 2012

WO 2010/120181 A1 (FEED CONTROL AS; KYRKJEBO JAN ERIK [NO] 21 Oct. 2010

U.S. Pat. No. 6,016,767 A (KYRKJEBO JAN ERIK [NO]) 25 Jan. 2000

### Problem to be Solved

The occupation of exposed places in open waters is nowadays, all around the world, consensually considered an inevitability for the expansion of aquaculture, in this case also called mariculture, due to the shortage of sheltered locations near the coast. Hence the need for a new generation of platforms intended to make feasible the fish farming in locations subject to adverse environmental conditions, e.g., storms, which are frequent in the open waters, where the fish farming platforms and cages are subject to such adverse environmental conditions, that is to say, for example, to the impact of large undulations, strong winds and/or high intensity sea currents. Therefore, the object of the present invention is to create a feeding distribution, production control and command platform for the operations inherent to fish farming in submersible cages, which has the capability to submerge under adverse environmental conditions, remaining balanced and with a high load capability.

### DESCRIPTION OF THE INVENTION

The feeding, control and command submersible platform according to the invention automatically performs the operations relating to the activities referred to in the table of pre-programmed routines, subject, however, to alteration through decision of the service operator, to whom it reports in real time, via radio, to the headquarters of the company on land. To be possible to enable the fish farming in offshore spaces where the environmental conditions did not allow the use of the prior art equipments, the platform according to the present invention must be capable of solving two main problems, that is, it must be able to submerge, maintaining the possibility of connection to energy and air power supplies, as well as the communication connections, and remain balanced.

For the resolution of the first problem the platform according to the invention has the ability to submerge in adverse environmental conditions, returning to the surface once such conditions are over. For this purpose, said platform comprises a ballasting and deballasting chamber, which leads the platform to a situation of submersion at the sea or of surface emersion, which makes it possible for said platform to submerge, for example, under heavy weather conditions, staying positioned between ten and thirty five meters deep, position where the impacts resulting from the undulation and/or from the sea currents which occur at the surface are drastically attenuated.

For the resolution of the second problem, the platform according to the invention has the capability to maintain its balance, as the feeding is distributed, due to the existence of an additional ballasting and deballasting arrangement inside each ration storage silo, which allows to maintain its balance, intended to receive seawater to compensate the weight of the ration which is being routed to the associated cages.

The aforementioned problems are solved, in accordance with the present invention, by a feeding, control and command submersible platform intended to perform the functions of feeding distribution, production control and command of the operations inherent to fish farming in submersible cages, which presents a trunk of cylinder or trunk of prism general shape, characterized in that it comprises:

a vertical central structure, which constitutes the core of the axial structure of the platform, and in which there are arranged, at least, a vertical auger screw distributor, and/or another conveyor device, a function distribution zone, a ration arriving container, n, a ration mixing container;

an upper structure comprising, around the vertical central structure, cabins for housing equipments, ration grain tanks with respective conveying and dosage ration devices, a ballastable circulating corridor, which surrounds the cabins and the grain tanks, and further by an outer circulating and mooring space for service vessels;

a lower structure comprising, around the vertical central structure, several ration silos, a platform ballasting central chamber, at least a solid ballast container, several ration silos comprises several containment vertical grids of the several ballasting and deballasting arrangements; and

a mooring arrangement, comprising several mooring buoys anchored at the bottom of the sea by means of hanging ropes and mooring ropes, said hanging ropes and mooring ropes being connected to each other at respective junction points by ropes, the platform being moored by means of mooring ropes to said junction points, and said platform (10) and said buoys (11) being interconnected by pipes and wirings (17).

In this embodiment of the invention the air supply and the electric power supply can be made by means of pipes and wirings from at least one air intake and at least one electric generator, which may consist of a solar panel, a wind generator or a diesel generator engine, installed in at least one buoy of the mooring arrangement of the platform.

In an alternative embodiment of the invention, the number of silos for ration storage may vary between six and twenty four.

In an embodiment of the invention, the ballasting and deballasting arrangements consist of ration consumption compensating bags made of flexible, impact-resistant and water-proof material.

In an embodiment of the invention, at least one of the platform mooring buoys has a radio or microwave communication antenna connected to the platform by means of wiring.

In a further alternative embodiment of the invention, the conveyor devices and the conveyor and dosage devices are auger screw devices and/or other devices, the other devices being able to be bucket conveyors.

In an embodiment of the invention, the discharge devices of the silos can each discharge one or two silos, varying as a function of the number of silos and the purposes to be attained by the ration distribution function.

The platform, according to the invention, when submerged, in addition to giving continuity to the feeding distribution, continues to perform control and command operating functions relative to cage fish farming, in security conditions, thus ensuring, without disruption, the operability of the system against any adverse environmental conditions. The submersion takes place when this is justified for the safety of said platform.

For this purpose, the platform according to the present invention is moored to an arrangement of buoys fixed at the bottom of the sea and in which there are arranged all the equipments which allow the supply of energy, of air and the communications of the platform with the outside.

The platform has computer equipments which allows to trigger the automatic execution of several functions, namely of programmed routines to control the feeding to the associated cages, the collection of production data images and of several parameters that characterize the environment in which it is processed the fish farming. The service operator, based in the office of the company on land, has the possibility to intervene in real time when it is desired to introduce rectifications, through commands transmitted via radio which overlaps to the programmed routines.

In order to proceed to the submersion of the platform one or more valves controlling the entry of seawater into the ballasting central chamber are opened and, for the platform to return to the surface, that is to say, emerge, compressed air is inflated into said ballasting chamber, by means of which it is carried out the deballasting thereof, which causes the emersion of the platform.

### BRIEF REFERENCE TO THE FIGURES

For a more complete understanding of the present invention reference is now made to the description which follows in conjunction with the accompanying drawings, which refers to an embodiment thereof provided by way of example only and which is not intended to limit the invention.

FIG. 1 shows a perspective view of the feeding, control and command submersible platform according to the embodiment of the present invention.

FIG. 2 shows a plan view of the relative position of the platform and of the mooring buoys.

FIG. 3 shows in an elevation view the relative position of the platform (at the surface and in submersion) and of the mooring buoys.

FIG. 4 shows a side elevational view of the platform of FIG. 1.

FIG. 5 shows a vertical sectional view through plane A-A′ passing through the axis of the platform of FIG. 1, shown in FIGS. 6 and 7, and shows the internal structure of the platform of FIG. 1.

FIG. 6 shows a horizontal sectional view through the plane B-B′ shown in FIG. 4 of the platform of FIG. 1.

FIG. 7 shows a horizontal sectional view through the plane C-C′ shown in FIG. 4 of the platform of FIG. 1.

FIGS. 8 and 9 shows sectional views through the vertical plane A-A′, shown in FIGS. 6 and 7, of the platform of FIG. 1.

### DETAILED DESCRIPTION OF AN EMBODIMENT OF THE PRESENT INVENTION

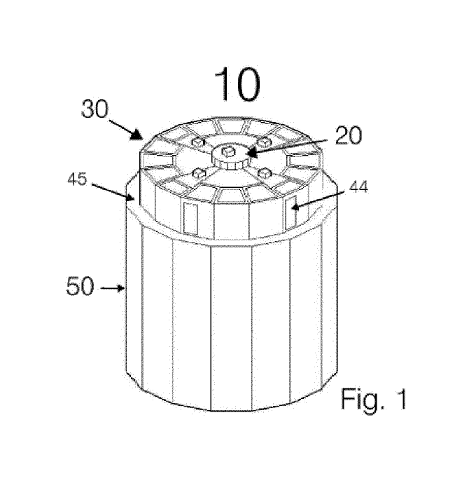

FIGS. 1 to 9 represent an embodiment of the present invention, which consists of a feeding, control and command submersible platform, which has sixteen silos for the ration storage.

FIG. 1 shows in a perspective view the feeding, control and command submersible platform (10), which presents a trunk of prism general shape and is composed by:

a vertical central structure (20), it only being visible in this figure its top, which in addition to being the core of the axial structure of the platform houses several equipments;

an upper structure (30) composed by four cabins for housing of the equipments, four ration grain tanks, and by the circulating corridor that surrounds the cabins and the grain tanks, protecting these spaces from the impact of the sea, but which is flooded in submerge situation, said corridor being provided with natural light, when in emersion, through the use of transparent materials in its ceiling, and also of 4 doors (44), being visible in the present figure two doors;

an outer circulating and mooring space (45) for service vessels;

a lower structure (50), being visible part of its sixteen ration silos.

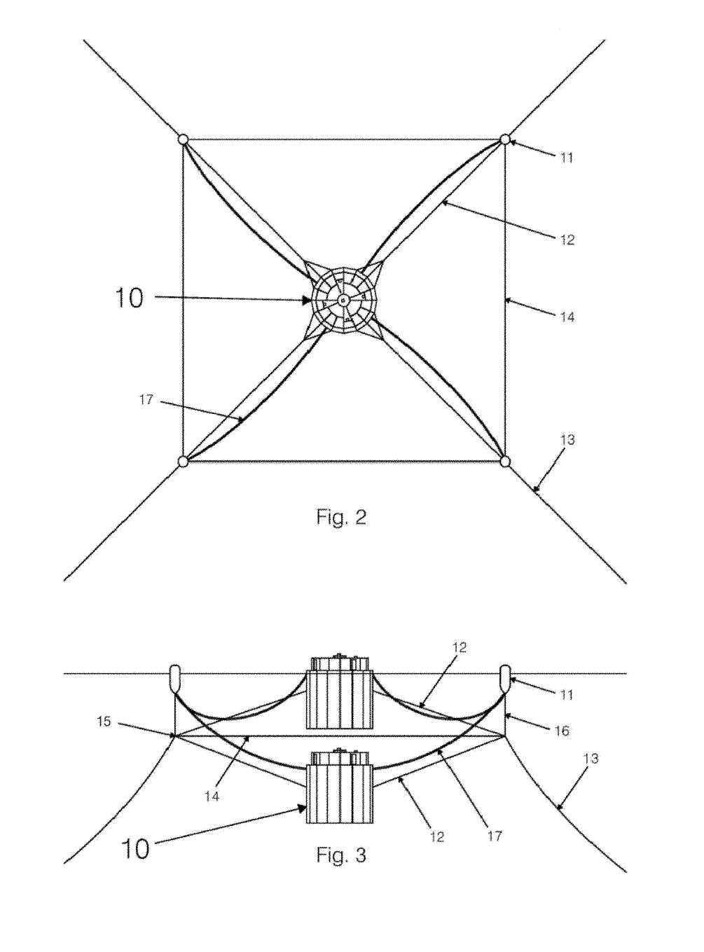

FIG. 2 shows in plan view the relative position of the platform (10) and of the mooring buoys (11), the platform mooring ropes (12), the ropes (13) for mooring of the buoys to the bottom of the sea, the ropes (14) that join between each other the mooring points (15) of the mooring ropes (13) to the ropes (16) hanging from the mooring buoys (visible in FIG. 3).

It further shows the pipes (17) which drive the air from the mooring buoys to the platform and the wirings (17), moored to said pipes, intended to drive the energy from a diesel generator engine set or other energy production systems installed on the buoys and the data transmission wirings from the platform to the radio antenna installed in one of said mooring buoys.

FIG. 3 shows in an elevational view the platform at the surface and in submersion, the moorings (12), pipes and wirings (17) connected to the mooring buoys (11), the ropes (14) which join between each other the mooring points (15) of the mooring ropes to the bottom of the sea (13) to the hanging ropes (16) of the mooring buoys.

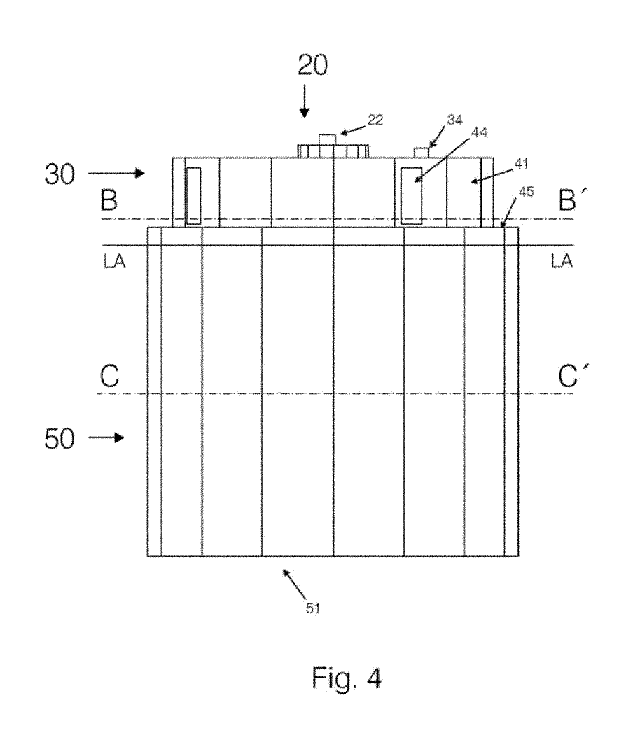

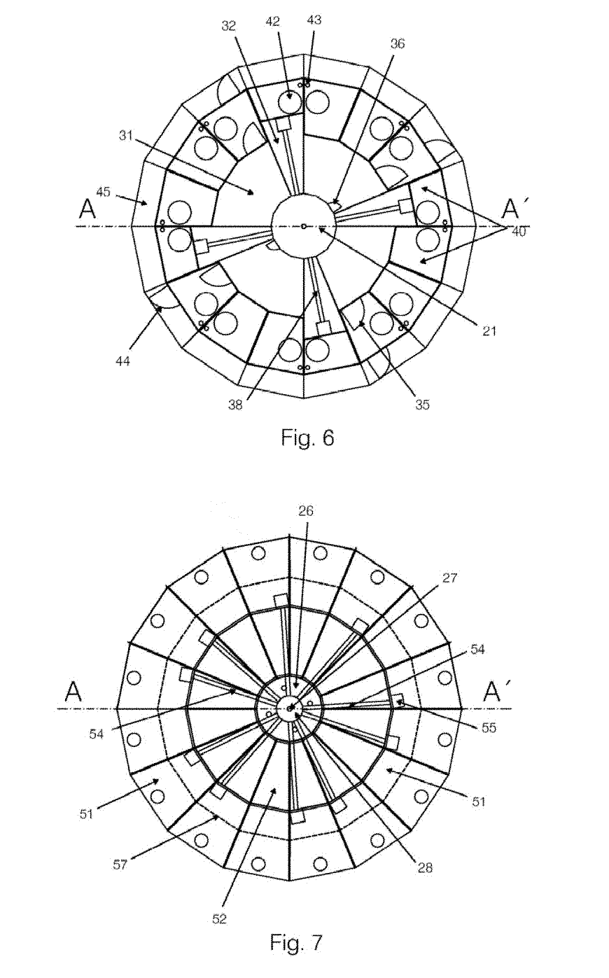

FIG. 4 is a side elevational view of the platform (10), where the position of the buoyancy line (LA) is indicated when said platform is at the surface, in the situation of flat sea, and the position of the section planes B-B′ and C-C′ which intercept the platform perpendicularly to its vertical axis, which horizontal sectional views are shown in FIGS. 6, and 7.

FIG. 4 shows the top of the vertical central structure (20) and the engine (22) of the vertical auger screw distributer intended to rise the ration. In the upper structure of the platform (30) it can be seen the outer wall (41) of the circulating corridor which protects, from the impact of the sea, the cabins that contain equipments and two access doors (44) to the outer mooring space (45) of the service vessels. At the top it can be seen the engine (34) of the auger screw distributor which drives the ration to the corresponding grain tank. The figure further shows the lower structure (50) where eight of the sixteen ration storage silos (51) are visible.

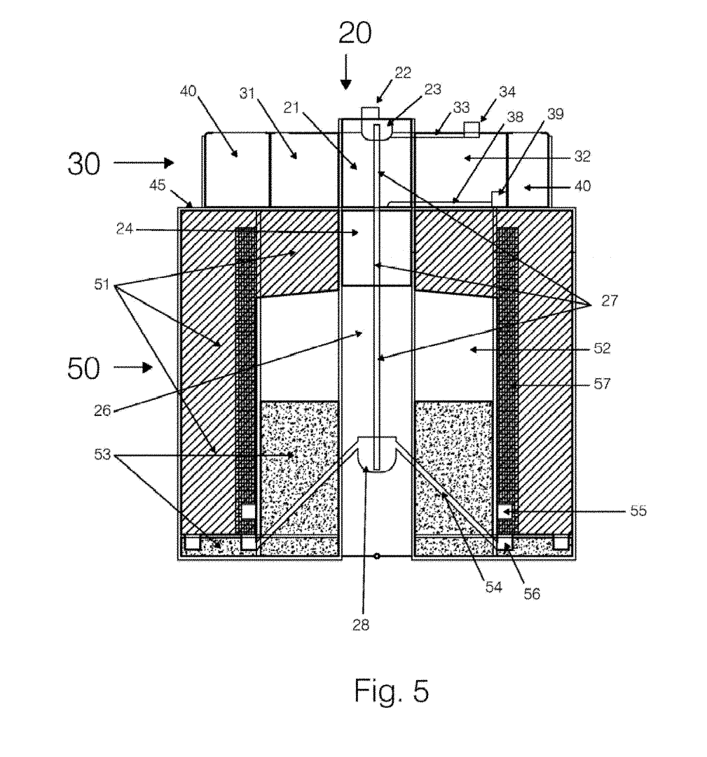

FIG. 5 shows the section through the vertical plane A-A′ of the platform (10), which position is shown in FIGS. 6 and 7. It is shown the vertical central structure (20), around which there are positioned the upper structure (30), above the horizontal plane defined by the upper bases of the ration storage silos and the lower structure (50) below said horizontal plane, said structure (50) being, in the emerged position of the platform, almost entirely below the water line (LA).

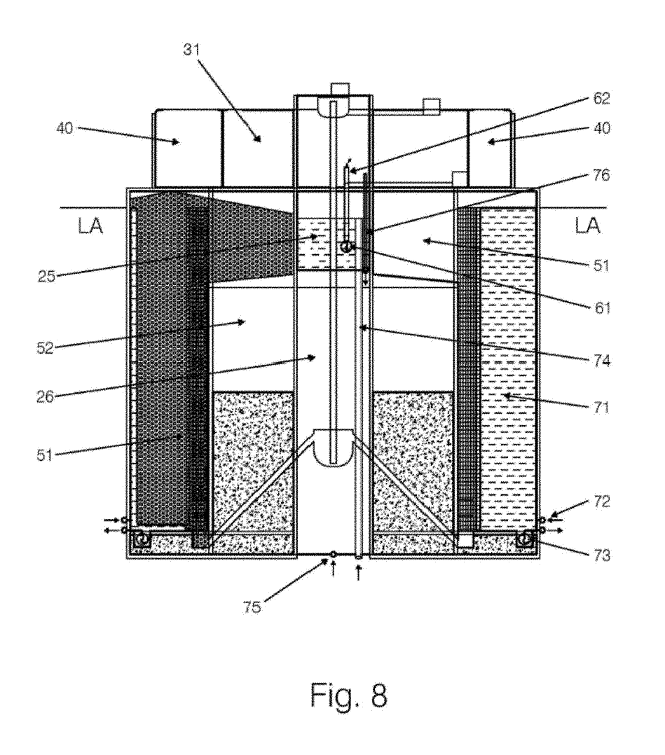

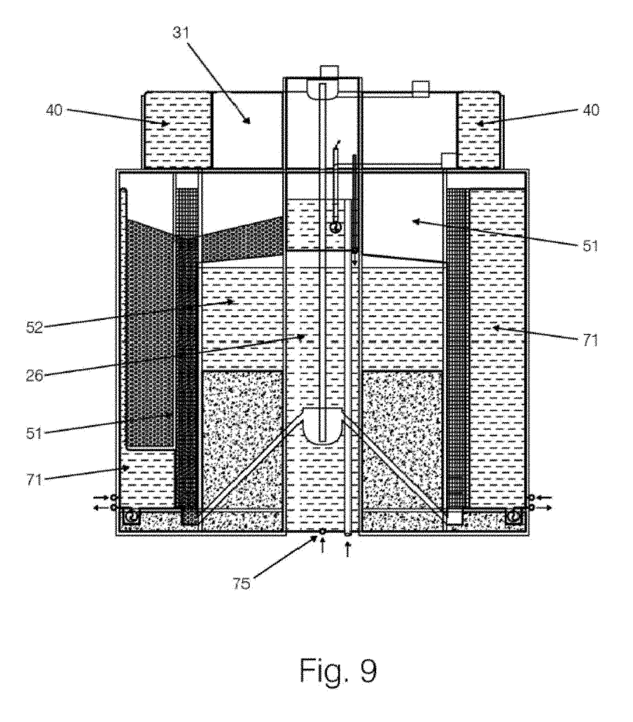

The vertical central structure (20) comprises, from top to bottom, a function distribution zone (21), to which follows in an immediately lower position, the ration mixing container (24) where the submerged pumps (61 visible in FIGS. 8 and 9) are located, intended to boost the water which drives the ration to the cages and, in the lower position, the space (26) forming part of the ballasting central chamber of the platform. In the space (21) it is seen the upper segment of the ration rising vertical auger screw distributor (27), the ration arriving container (23), the container which contains the engine (22) of said ration rising system, the starting segment (33) of the auger screw distributor which conveys the ration into the grain tank (32) and the end segment (38) of the auger screw conveyors which process the dosage of the ration, convoying it to the ration mixing container with the seawater. In the ration mixing container (24), it is seen the intermediate segment of the ration rising vertical auger screw distributor (27), the remaining equipment occupying this ration mixing container (24) shown in FIGS. 8 and 9. In the space (26) there are shown the lower segment of the ration rising vertical auger screw distributor (27), the ration loading container (28) and the end segments of the auger screw conveyors (54) which convey the ration from the silos to the container (28).

In the upper structure (30) there are shown in this section a cabin (31), the ballastable circulating corridor (40) giving access to the cabins, the ration grain tank (32), with the ration conveying auger screw distributor (33) to said grain tank and its engine (34) and, further, the ration dosage auger screw conveyors (38) which drive it from the grain container (32) to the ration mixing container to be mixed with seawater and their engines (39). It is also shown in the peripheral position the mooring outer circulating space (45) for service vessels.

In the lower structure (50) there are shown in the present section the ration storage silos (51), the free space integrated in the ballasting central chamber (52), the gravel ballasting container (53), the auger screw distributers (54) for moving the ration, which connect the silos to the ration loading container (28), the respective engines (55) and the loading containers (56) of the auger screw distributers (54) and the containment vertical grids (57) of the water bag (71 visible in FIGS. 8 and 9) intended to compensate the weight of the consumed ration

FIG. 6 shows the horizontal section of the platform (10) through plane B-B′ which position is shown in FIG. 4. It is shown the space occupied by the function distribution area (21), surrounded by four cabins (31) intended to house equipments (not represented), with the respective access doors (35), the two access doors (36) to the function distribution area, and, by the grain tanks (32) adjacent relative to each cabin, existing, at the base of each grain tank, auger screw convoying and dosage devices (38) intended to dose the ration to distribute. In the ballastable circulating corridor (40) there are arranged intake tight trapdoors on each silo (42) and ration loading mouths (43). The doors (44) provide the passage between the ballastable circulating corridor and the mooring outer circulating space (45) for service vessels.

FIG. 7 shows the horizontal section of the platform (10) through the plane C-C′ which position is shown in FIG. 4. It is shown the space (26) in which central position it is located the auger screw distributor (27) intended to rise the ration and, in a projection, the loading container thereof (28), in addition to the pipes (74 visible in FIG. 8), intended to supply with seawater the ration mixing container (24), located at an upper level. The space (26), at the section level, is surrounded by the gravel ballasting container (53), which material is not represented in order to show the auger screw conveyors (54) which are intended to move the ration from the silos with destination to the loading container (28). A further horizontal section more above would allow to see, in the same position, the ballasting central chamber (52) of the platform visible in FIG. 5. In the periphery of the present figure there are shown in section the ration silos (51) and, in its interior, the vertical grids (57), the places where there are located the engines (55) of the auger screw conveyors (54) which empty the silos and the places where there are installed the submerged pumps intended to empty the seawater accumulated in the compensating bags (71 visible in FIG. 8) of the weight of the consumed ration. With respect to ration movement, each one of the eight of the auger screw conveyors (54) discharges only one silo, unloading each one of the remaining two silos in the adjacent position.

FIGS. 8 and 9 show the section through the vertical plane A-A′ of the platform (10) which position is indicated in FIGS. 6 and 7, with the aim to show, in addition to the equipments not mentioned in the previous figures, the different filling situations of the silos with ration and/or the different degrees of filling with water of the compensating bag of the weight of consumed ration (71) and, further, the air filled ballasting central chamber (platform floating at the surface) shown in FIG. 8, or filled with water (submerged platform) shown in FIG. 9. FIG. 8 shows the ration mixing container (24) where it is made the mixing of the ration with the seawater, in order to be boosted by the submerged pump (61), through the pipes (62), to the cabins (31), where there are devices (not represented) intended to its routing, through submerged pipes to the cages. The pipe (74) is intended to supply with seawater the ration mixing container (24), having a safety valve (not represented) intended to prevent that the water in the container from exceeding a predetermined operating level. FIG. 8 further shows the ration consumption compensating bags (71) made of flexible, impact-resistant and water-impermeable plastic material. The inlet of the seawater in said compensating bags (71) is controlled by the valves (72) whose operation allows to regulate the necessary quantity to compensate the weight of the ration that is being consumed and, therefore, maintain the balance of the platform. The submerged pumps (73) are intended to empty said bags (71) in order to allow the filling of the silos with the ration. At the present section the ballasting central chamber (26 and 52) is filled with air, whereby the platform is floating at the surface. The control of the filling with water to ballast the ballasting central chamber is made by the valve (75) and, the air inlet for expelling the water from that space (26, 52), in order for the platform (10) to return to the surface, is made through the pipe (76) connected to an air compressor installed in a cabin (31). FIG. 8 further shows, on the left side of the drawing, the silo (51) filled with ration and the corresponding empty ration consumption compensating bag (71), which situation is reversed in another silo (51) located on the right side of the drawing. The ballasting central chamber of the platform (26 and 52) is filled with air, whereby the platform is at the surface with the indicated position of the water line (LA).

FIG. 9 shows the section through the vertical plane A-A′ of the platform (10) which position is shown in FIGS. 6 and 7. It is shown, in particular, the situation of the platform in submersion with the ballasting central chamber (52 and 26) filled with water, as well as the flooded circulating corridor (40).

The platform (10), which normally operates at the surface, has components and equipments, whose direct or indirect relationship with the submersion and immersion capability of the platform (10) is explained in the following.

In FIGS. 5, 6, 8 and 9 there is represented the function distribution area (21) which constitutes a passage space for wirings and pipes.

The wirings (not represented) are intended for energy transmission, data transmission and to convoy command actions between the cabin (31) (where the command computerized central of all routine automatic operations is located) and the commanded equipments, located in several places of the platform, namely in the remaining cabins (31).

The air conveying pipes (76) leave the cabin (31) (where the air compressor is located) and goes to the ballasting central chamber (26 and 52), to promote the expulsion of the water and allow the return of the platform to the surface.

In the two containers (25) where it is processed the mixing of the ration with the seawater there are two submerged pumps (61), one in each container, which boost the water through the pipes (62) into two cabins (31), where are located the equipments (not represented) intended to route the ration to each one of the associated cages. In parallel with the pipes intended to distribute the ration there flows from those cabins (31) other compressed air conveying pipes (not represented) intended for the ballasting spaces of each cage to allow their emersion after the end of the adverse environmental conditions.

There are also pipes (74), intended for capturing seawater for the supply of said ration mixing container (24), which pipes are provided with water intake control valves (not represented), which prevent seawater from rising, in each ration mixing container (24), above a predetermined safety level.

FIGS. 5, 6, 8 and 9 shows the upper structure (30) comprising four cabins (31) intended to house equipments (not represented). One of the cabins contains the control computer equipment of the routine operations of the platform, two cabins, located in opposite positions, contains the routing devices of the water pipes with mixed ration and the devices of the compressed air pipes for each of the associated cages, and the fourth cabin contains the air compressor for the deballasting processes of the platform and of the associated cages. The cabins (31) and the adjacent ration grain tanks (32) are surrounded by a corridor (40) which protects them from the impact of the sea, but which is flooded during the submersion process. There is also a mooring outer circulating space (45) for service vessels. All the cabins have an access door (35) to the ballastable circulating corridor (40), which doors are tight to the water that fills the corridor, when the platform is submerged. Two of the cabins (31) have access doors (36) to the function distribution area (21). The ballastable circulating corridor (40) is provided with a cover in transparent material to allow the natural light access to that working area when the platform is at the surface.

Operation: The equipments housed in the cabins are intended to drive the operating routines of the platform, both at the surface and in submersion, namely the ration distribution to the outside of the platform, the collection and treatment of production parameters, and to allow command interventions that overlap to the established routines, whenever the operator, installed in the company's office, so deems it to be necessary, in dialogue, via radio, with the computer system installed on the platform. The ballastable circulating corridor (40) is intended to allow the access to the cabins and to the silos, when the platform is at the surface and sheltered from the entrance of seawater. For this purpose, the entrance into this corridor is made using the door located in a more sheltered position with respect to the direction of the waves and of the wind in each moment, in front of which the service vessel will be moored.

FIGS. 5, 7, 8 and 9 show the lower structure (50) of the platform (10) comprising, around the vertical central structure (20), sixteen silos (51), in the shape of trapezoidal section prisms. The vertical walls of the silos located in a position closest to the axis of the platform restrict the ballasting central chamber (26 and 52) and have, inferiorly, in an attached position, the gravel ballasting container (53).

Each silo has in the upper base an inlet tight trapdoor (42) intended to allow the inspection of the inside thereof, and a ration supply mouthpiece (43).

Each silo contains in its interior a compensating bag (71) of flexible, impact-resistant and water-impermeable plastic material, intended to be filled with seawater as the ration is being consumed, thereby maintaining the balance of the platform. For this purpose, the bag communicates with the outside through a tube for entrance of the seawater, which is controlled by a valve (72), whose operation allows to adjust the volume of the incoming water in order to compensate the weight of the ration which is being consumed. In order to allow the silo to be filled with ration, the water existing in the compensating bag (71) is previously launched to the outside, through the operation of a submerged pump (73) located in its interior. The compensating bag adheres to the walls of the silo with which it contacts and is restrained by a vertical grid (57) which defines its volume as it fills with water.

The platform is connected by pipes and wirings to the mooring buoys from where it receives air and electric energy for the operation of the equipments thereof, as well as for the radio communication with the company's headquarters on land.

When the platform (10) is at the surface, the ballasting central chamber (26 and 52) is filled with air. In the face of a storm threat, the valve (75) is opened, allowing water to enter which causes the platform to submerge. After the storm has passed, in order for the platform to return to the surface, an air compressor is activated which, through the pipes (76), promotes the deballasting through the action of the air, of the existing water in the ballasting central chamber.

When the sinking of the platform is effected, the circulating corridor (40) is flooded as the platform sinks, through the entrance of the seawater through the valves located at the level of the corridor floor (not represented) and the air outlet through the valves located close to the corridor ceiling (not represented). In the immersion process, the water and air flows have opposite directions, accompanying the rising of the position of the platform relative to the water line.

The flooding of the circulating corridor (40) and the compensation, within each silo, of the weight of consumed ration through the corresponding filling with seawater of the compensating bag (71), allows the volume of the ballasting central chamber (26 and 52) to be minimized, which corresponds to the dimension of the closed volumes located above the water line (LA) when the platform floats at the surface: the function distribution area (21), the equipment cabins (31), the grain tanks (32) in adjacent position and the upper fraction of the silos (51). Without recourse to these embodiments, the ballasting central chamber would have such a large volume that would render the invention unviable.

The present invention covers all possible combinations of the embodiment and the alternative embodiments mentioned herein.

1-6. (canceled)

7. A feeding, control and command submersible platform intended to perform the functions of feeding distribution, control of production and command of operations inherent to fish farming in submersible cages, which has the capability to submerge under adverse environmental conditions, remaining balanced and with a high load capability; which presents a trunk of cylinder or trunk of prism general shape, comprising:
a vertical central structure, which constitutes the core of the axial structure of the platform, and in which there are arranged, at least, a vertical auger screw distributor, or, at least, another conveyor device, a function distribution zone, a ration arriving container, a ration mixing container in the interior of which is mixed the ration with the seawater, containing the submerged pumps, intended to boost the water which drives the ration to the cages, a space which is part of the ballasting central chamber, a ration loading container;
an upper structure having, around the vertical central structure, cabins for housing equipments, ration grain tanks with respective conveying and dosage screw conveyor devices, a ballastable circulating corridor, which surrounds the cabins and the grain tanks, and further by an outer circulating and mooring space for service vessels;
the vertical central structure having, from top to bottom, a function distribution zone, to which follows in an immediately lower position, the ration mixing container where the submerged pumps are located, intended to boost the water current which drives the ration to the cages and, in the lower position, the space forming part of the ballasting central chamber of the platform, in which are located the ration loading container and the end segments of the auger screw conveyors which convey the ration from the silos to the container;
a lower structure having, around the vertical central structure, several ration silos, a ballasting central chamber, at least a solid ballast container, several loading containers, wherein the several ration silos includes several containment vertical grids of the several ballasting and deballasting arrangements with ration consumption compensating bags and pumps disposed inside the ration storage silos; and
a mooring arrangement, having several mooring buoys anchored at the bottom of the sea by hanging ropes and mooring ropes, said hanging ropesmooring ropes being connected to each other at respective junction points by ropes, the platform being moored by mooring ropes to said junction points, and said platform and said buoys being interconnected by pipes and wirings for supplying air and electric power from said buoys to said platform.

8. A feeding, control and command submersible platform according to claim 7, wherein the number of silos for ration storage vary between six and twenty four.

9. A feeding, control and command submersible platform according to claim 7, wherein the ration consumption compensating bags are made of flexible, impact-resistant and water-proof material.

10. A feeding, control and command submersible platform according to claim 7, wherein the air supply and the electric power supply is made by pipes and wirings from at least one air intake and at least one electric generator, which may include a solar panel, a wind generator, and/or a diesel generator engine, installed in at least one buoy of the mooring arrangement of the platform.

11. A feeding, control and command submersible platform according to claim 7, wherein in at least one of the platform mooring buoys there is a radio or microwave communication antenna.

12. A feeding, control and command submersible platform according to claim 7, wherein the conveyor devices are auger screw devices or other devices, the other devices being bucket conveyors.
